(19) United States
(12) Patent Application Publication
(10) Pub. No.: US 2015/0165389 A1
(43) Pub. Date: Jun. 18, 2015

(54) Forward Osmosis, Reverse Osmosis, and Nano/Micro Filtration Membrane Structures

(71) Applicant: Battelle Memorial Institute, Columbus, OH (US)

(72) Inventors: Vincent D. McGinniss, Indian Harbour Beach, FL (US); Jay Randall Sayre, New Albany, OH (US); Olga B. Koper, Dublin, OH (US); Gregory R. White, Hilliard, OH (US); David C. Masterson, Grove City, OH (US); Kevin B. Spahr, Columbus, OH (US); Jeffrey Ellis, Gahanna, OH (US); John Dee Clay, Gahanna, OH (US); John R. Stickel, London, OH (US); Manfred Luttinger, Upper Arlington, OH (US); Ann Lane, Upper Arlington, OH (US); Jerry K. Mueller, JR., Columbus, OH (US)

(73) Assignee: BATTELLE MEMORIAL INSTITUTE, Columbus, OH (US)

(21) Appl. No.: 14/108,402

(22) Filed: Dec. 17, 2013

(51) Int. Cl. B01D 71/70; B01D 71/56; B01D 61/00; B01D 61/02; B01D 61/14; C08L 1/12; C08L 29/04; C08L 75/04; C08L 77/06; C08L 79/02; C08L 27/06; C08L 31/04; C08L 79/04; C08L 81/04; C08L 81/06; G06F 17/11; B01D 67/00

(52) U.S. Cl. CPC B01D 71/70; B01D 67/0088; B01D 67/0086; B01D 71/56; B01D 61/002; B01D 61/02; B01D 61/147; B01D 61/027; C08L 1/12; C08L 29/04; C08L 75/04; C08L 77/06; C08L 79/02; C08L 27/06; C08L 31/04; C08L 79/04; C08L 81/04; C08L 81/06; B01D 67/0013; G06F 17/11; B01D 2323/40

(57) ABSTRACT

Disclosed is a composition for forming or treating reverse osmosis (RO), forward osmosis (FO), microfiltration (MF), or nanofiltration (NF) membranes, which includes a stable liquid blend of two of the following polymers: an oxygen polymer, a nitrogen polymer, and a sulfur polymer, where each polymer in a blend have matched solubility parameters; provided, that a nitrogen polymer can be in the form of a powder; where the weight ratio of polymers in each blend can range from 1:99 to 99:1; where each polymer optionally can be halogenated; where any polymer can be dispersed in a solvent for forming the blend.

### CROSS-REFERENCE TO RELATED APPLICATIONS

This application claims benefit of U.S. provisional application 61/498,031 filed on Jun. 17, 2011.

### STATEMENT REGARDING FEDERALLY SPONSORED RESEARCH

Not applicable,

### BACKGROUND

Since the 1960's there have been numerous developments in the use of Cellulose Acetate (CA), Cellulose Triacetate (CTA), and other cellulose polymer derivatives to make membranes that are suitable for the Reverse Osmosis (RO) desalination of sea/saline waters [I&EC Process Design and Development, Vol. 4, No. 2, April 1965, pp. 207-212; IBID, Vol. 6, No. 1, March 1967, pp. 23-32; Polymer Letters, Vol. 11, pp. 603-608 (1973); Desalination, 61 (1987) pp. 211-235; HWAQHAK KONGHAK Vol. 28, No. 5, October, (1990), pp. 602-611; U.S. Pat. No. 3,673,084; U.S. Pat. No. 3,807,571 and; U.S. Pat. No. 3,878,276].

In recent years there have also been modifications of CTA/CA polymers for use in Forward Osmosis (FO) membranes as disclosed in U.S. Pat. No. 7,445,712.

### BRIEF SUMMARY

The current disclosure is a composition for forming reverse osmosis (RO), forward osmosis (FO), or nano or micro filtration (NF) membranes from a stable liquid blend of two of the following polymers: an oxygen polymer, a nitrogen polymer, and a sulfur polymer, where each polymer in a blend have matched solubility parameters; provided, that a nitrogen polymer when incompatible can be in the form of a powder; where the weight ratio of polymers in each blend can range from 1:99 to 99:1; where each polymer optionally can be halogenated; where any polymer can be dispersed in a solvent for forming a blend.

By “oxygen polymer”, we mean a polymer having as its main structure or repeating units, —CHO groups. By nitrogen polymer, we mean a nitrogen backbone polymer (—NHO repeating units) typified by special nylons, amines, amides, polyurethanes, and the like. By sulfur polymer, we mean a sulfur backbone polymer (—SHO repeating units) typified by polysulfides, polysulfones, polyethersulfones, and the like. Note: if the nitrogen polymer is insoluble, it may be incorporated as a powder into the oxygen polymer or sulfur polymer. Such polymers typically will be provided in a solvent or blend of solvents.

The method of forming such RO, FO, or NF membranes starts with casting a wet film or extruding a hollow fiber of a membrane composition comprising a stable liquid blend of two of the following polymers: oxygen polymer, a nitrogen polymer, and a sulfur polymer, where each polymer in a blend have matched solubility parameters; provided, that a nitrogen polymer can be in the form of a powder; where the weight ratio of polymers in each blend can range from 1:99 to 99:1; where each polymer optionally can be halogenated; where any polymer can be dispersed in a solvent for forming a blend.

Next, the solvent is evaporated from said the film or extruded hollow fiber, where low solvent evaporation times (e.g., seconds to a few minutes) produce an ultrafiltration or nanofiltration morphologies, medium solvent evaporation times (e.g., 3-5 minutes) produce FO morphology, and long evaporation times (e.g., 5-30 minutes) produce reverse osmosis morphology.

The evaporated cast film or extruded hollow fiber is water quenched, where the quench water optionally can contain one or more of inorganic or organic microparticles or nanoparticles; nonionic, anionic, cationic, zwitterionic polymers; or amino acids

The quenched cast film or extruded hollow fiber then is annealed and optionally microembossed.

The foregoing processing steps are represented in FIG. 1.

### BRIEF DESCRIPTION OF THE DRAWINGS

For a fuller understanding of the nature and advantages of the present media and process, reference should be had to the following detailed description taken in connection with the accompanying drawings, in which:

FIG. 1 shows the processing steps disclosed herein for forming/treating UF, NF, RO, and FO membranes;

FIG. 2 is a bar graph of the data recorded in Table 8 of Example 4;

FIG. 3 is the test pattern described in Example 11;

FIG. 4 is a general model that helps us understand the ability of different additives to enhance the fouling resistance of a membrane treatment or formulation/additive modification based on the data reported in Example 13; and

FIG. 5 illustrates an alternative pre-filter treatment use for the unique membrane treating compositions disclosed herein.

The drawings will be described in further detail below.

### DETAILED DESCRIPTION

### Introduction

The disclosed water treatment membrane platform technology is based on unique combinations of commercially available polymers and specialty materials to produce stable and efficient membranes for forward osmosis (FO), nanofiltration (NF), microfiltration (MF), and reverse osmosis (RO) applications. The factors considered in designing membranes with the desired characteristics are Hansen solubility parameters of the polymer blend, zeta potential and surface energies of the membrane, surface roughness as well as its hydrophilic/hydrophobic properties. Creating a balance of all these variables is difficult to achieve with a single or two component blends, thus the disclosed technology incorporates other polymer or inorganic materials and nanomaterials, as well as novel processing techniques for enhanced control of flux and salt rejection to design the final membrane system. These additives, as well as bulk and surface modification techniques, provide enhanced antifouling and chlorine resistance properties.

### Formulations

The first order design of a polymer blend starts with understanding the relationships between the Hansen solubility parameters associated with the different classes and structures that are being considered for the system. For example, cellulose acetate (CA) has the following dispersion, polar, hydrogen bonding solubility parameter values (MPa)^{1/2}: δ_{d}=18.6; δₚ=12.7; δₕ, =11, respectively. In order to create a compatible polymer with CA, the solubility parameters for both the CA and the other polymer must be within 3 units of each other, for each property. If the individual solubility parameters of both polymers are significantly different (larger or smaller) then an unstable system and an incompatible blend would be produced. For example, a CA/Nylon/Polyamide membrane is a system where the individual solubility components of the CA closely match the solubility components of the P1 material and are compatible. A dynamic mechanical analysis of this blend showed a single glass transition peak (Tg) indicating that the two polymers are miscible. Incompatible or polymer dispersions of two different polymers with large differences in their solubility parameters can exhibit two Tg peaks indicating separate phases in the system.

The hydrophilic or hydrophobic nature of the polymer can be determined from its water sensitivity or % oxygen content [McGinniss Equation χ_{Oxygen}; U.S. Pat. No. 4,566,906] contained in the backbone of the polymer structure. For example polyvinyl alcohol and low alkyl functional acrylics absorb water, or are sensitive to water, while non-oxygenated polymers, like polyolefins and polystyrenes, are significantly less sensitive to water. Therefore, the disclosed NF, MF, FO, and RO membranes are comprised of unique combinations of water-sensitive, oxygen-containing polymers (cellulosics, acrylics, polyesters); water-sensitive, nitrogen- or sulfur-containing polymers (nylons, sulfones); water soluble/dispersible anion and cation polymers; water soluble/dispersible nonionic/zwitterionic polymers; polymers with low sensitivities to water (elastomers, aromatic polymers); and such crosslinking polymer materials as epoxies, polyurethanes/amides, and melamine resins. The disclosed compositions of matter are different in that not all nitrogen containing polymers are compatible with oxygen or sulfur containing polymer structures and visa versa. In Table 1 are selected solubility compatibility listings for several examples of the types/classes of polymers suitable for this invention.

TABLE 1
Hansen Solubility Parameters for
Selected Polymer Blend Combinations

| | | | Hydrogen |
|---|---|---|---|
| Polymers | Dispersion | Polar | Bonding |
| Cellulose Acetate | 18.20 | 12.40 | 10.80 |
| (soluble in dioxane) | | | |
| Cellulose Triacetate | 19 | 10 | 9.5-15 |
| (soluble in dioxane) | | | |
| Dioxane | 19 | 1.8 | 7.4 |
| ELVAMIDE 8061/Nylon/Polyamide | 18-19 | 2-10 | 7-10 |
| (soluble in dioxane) | | | |
| EPIKOTE 1001 | 20 | 10.32 | 10.11 |
| (Epoxy Resin) | | | |
| DESMOPHEN 850 | 21.54 | 14.94 | 12.28 |
| (Polyurethane) | | | |
| VERSAMIDE 961 | 18.9 | 9.60 | 11.10 |
| (Polyamide) | | | |
| PSU ULTRON | 19.70 | 8.30 | 8.30 |
| (Polysulfone) | | | |
| MOWILITH 50 PVAC | 20.93 | 11.27 | 9.66 |
| (Polyvinyl Acetate) | | | |
| Cymel 300 | 19.35 | 12.83 | 12.87 |
| (Amino Resins) | | | |
| PLASTOKYD AC4X | 23.9 | 7.8 | 8.8 |
| (Acrylic Modified Alkyd) | | | |
| VIPLA KR | 18.4 | 6.60 | 8.00 |
| (Polyvinyl Chloride) | | | |

Note:
That Nylon 66 and other Nylon polymers that are not soluble in the same solvents as the primary polymer blend solvents like dioxane can be added as powders. The solubility parameters for Nylon 66 are dispersion = 16, Polar = 11 and Hydrogen Bonding = 24.
All values for the solubility parameters are in (MPa)^{1/2} units and all the information for this table came from “Hansen Solubility Parameters-Second Edition/a Users Handbook” by Charles M. Hansen CRC Press Boca Raton Florida, 2007.
Note:
To have compatible polymer blends the different solubility parameters for each polymer should be 1-3 units in closeness or the different polymer materials should be very soluble or dispersible in the same solvents.

After downselection of polymer blends, based on the modeling output, membranes were produced from various combinations of polymers based on cellulose acetate, cellulose triacetate, polyamides, polysulfones, and other polymers/additives. Production variables included solvent evaporation time, water bath quench/annealing time, and temperature.

### Membrane Processing Conditions

The first step in making the membrane is to take the membrane polymer/solvent solution and apply it to a glass or other composition plate and draw down a wet film with a draw down bar set at a thickness of, say, for example, 10 mils.

In a polymer/solvent cast flat sheet membrane or extruded hollow fiber membrane the solvent evaporation times are critical for creating the initial morphology of the membrane before it is water quenched and annealed into its final structure. For the polymers/solvents of this disclosure, solvent evaporation (static or forced air/room temperature or elevated to 100° C.) times less than a minute, produce ultrafiltration and nanofiltration membranes, while solvent evaporation times of 15-20 seconds or between 1 to 3 minutes and 3 to 30 minutes produce morphologies suitable for FO and RO membrane technologies respectively. Similar solvent evaporation times also would apply to hollow fibers after they are extruded. It also is possible to create membrane particles by spraying the polymer/solvent solutions form the initial desired morphologies and then quench them in water to maintain their porosity, so as to be used as a novel nano or course (millimeter) filtration media as a pretreatment process for FO or RO membrane processes.

After the initial morphology is created, the flat sheets or hollow fibers or particles are quenched (dipped or exposed to a water spray) in water (5 minutes at ice water or room temperature or less at elevated temperatures) to solidify the structure followed by an additional heat treatment (wet or dry) to anneal the system and lock in the final structure.

The thickness of the flat sheet membranes can have an active 0.1 to 0.2 micron size dense layer on a much thicker (1-30 mils) substrate layer, while hollow fibers can have outside diameters of 85 to 2000 microns and inside diameters between 42 to 200 microns.

The water bath quench process can be run at low temperatures (ice water), room temperature or elevated temperatures (50° C. or less) while the annealing step is usually run wet at 50° C.-80° C. for 5 to 10 minutes and cosolvents, such as, for example, methanol, also can be added to help the coagulation process. The quench water optionally can contain one or more of inorganic or organic microparticles or nanoparticles; nonionic, anionic, cationic, zwitterionic polymers; or amino acids. After downselection of polymer blends, based on the modeling output, membranes were produced from various combinations of polymers based on cellulose acetate, cellulose triacetate, polyamides, and polysulfones. Production variables included solvent evaporation time, water bath quench/annealing time, and temperature.

The quenched cast film or extruded hollow fiber then is annealed in a separate water bath at a temperature ranging between about 50° to 80° C. for about 5 to 10 minutes

### Additives

The additives that can be incorporated into the membrane polymer formulation casting or extrusion solutions and water quench baths are as follows:
Anionic polymers or oligomers.
Nonionic polymers or oligomers.
Cationic polymers or oligomers.
Polymers that contain zwitterions.
Polymers that contain amino acids and chelating functionality.
Amino acids and chelating agents.
Micron or nanosize organic or inorganic materials.
Polymeric powders.
Zeolites.
Carbon fibers, polymeric fibers, inorganic fibers, or graphene.
Crosslinking agents like epoxy/amine; diisocyanates/polyols/amines; melamines/acids, etc.

The additives listed above can be either added to the membrane polymer solutions as homogeneous mixtures or dispersions before casting or extruding or they can be added (solubilized or dispersed) into the water quench bath that incorporated the additives into the membrane during the coagulation of the polymer films to form the final membrane structure. The additives also can remain thermoplastic or converted into thermosetting structures if so desired.

### Experimental Details

### General Membrane Preparation Procedures

Prepare FO or RO membrane solutions by first dissolving CA or CTA or other water-sensitive polymers in dioxane. Add acetone and mix to dissolve, methanol, and lastly monofunctional (lactic acid) or multifunctional acids. For hybrid solutions containing nylon or other water-sensitive nitrogen or sulfur-sensitive polymers or polymers with low sensitivity to water, add them (nylon) prior to the acids (lactic acid).

Draw down this solution onto a glass plate using a Gardener blade set at 10 mil thickness followed by immersion in room temperature tap water (note—another part of this disclosure is to include water soluble anionic, cationic or nonionic polymers in the water quench solution for improving the internal concentration polarization response of the membrane and improve its antifouling properties) for up to 5 minutes or until the membrane film separates from the glass and incorporates the water soluble membrane property enhancement polymers if so desired. Rinse with tap water and store in a zip lock bag containing 100 ml tap water.

RO composite membranes are assembled on a polysulfone/nonwoven fabric using a dilute poly(vinyl alcohol) adhesive layer to hold an FO membrane to the polysulfone support. Filter paper also can be used directly without an adhesive binder to support the membrane in the RO test cell. This composite RO membrane is then dried at 55° C. overnight.

### FO and RO Experimental Equipment and Procedures Standard Operating Procedure (SOP)

### Testing of Forward Osmosis Membranes

### Scope/Purpose

Pressure-driven systems, like reverse osmosis (RO), have been studied a great deal because of their effectiveness in water purification. With the expanding need for clean water that can be produced economically, interest in forward osmosis systems has grown. Forward osmosis (FO) membranes operate similarly to RO membranes in that both membranes allow water to move across a semi-permeable barrier while inhibiting the flow of solutes. Unlike pressure-driven RO systems, FO systems utilize the osmotic pressure differential between the draw solution and feed solution, which is naturally occurring.

In this testing, deionized (DI) water and salt (NaCl) water will be used in an FO system to determine membrane efficiencies.

### Materials

1. Membrane to be tested (FO membranes need to be stored in DI water and remain saturated during use),
2. FO test platform:

a. Ring stands and clamps

b. FO apparatus (graduated DI/NaCl cells)

c. Strap wrench

d. Motor operated stirring rods

e. DI water

f. NaCl solution
3. Membrane Log Book and Laboratory Record Book
4. Razor blade
5. Membrane template
6. Sampling equipment:
   a. Automated pipettor and two (2) 10 mL pipettes (one for DI and one for NaCl)
   b. Glass vials (×6)
   c. Vial stand
   d. Salinity meter
7. Analytical balance

### Procedure

1. Obtain membrane to be tested and create entry in Membrane Log Book. The entry should include the following:
   a. Names of the people running the test.
   b. Date that the test was run.
   c. Operating System: FO
   d. Membrane identification information (either name of membrane or identification number if running a Battelle made membrane).
2. Prep countertop. Spray countertop with IPA, then wipe dry with Kimwipe. Spray countertop with DI water and wipe dry. Spray countertop with DI water and leave wet.
3. Lay membrane flat on moist countertop.
4. Identify any imperfections in membrane and avoid. Use central area of membrane sheet for best quality membrane.
5. Cut membrane to correct dimensions using membrane template and razor blade.
6. Pat off excess water droplets on membrane with a Kimwipe. Weigh membrane to three decimal places on an analytical balance, and record this value as new weight (wet) in the laboratory book.
7. Loosen coupling with strap wrench to separate the DI and NaCl cells. Place membrane in between two cells, ensuring smooth side of membrane is towards NaCl cell.
8. Hand-tighten coupling making sure cells are parallel and line up properly.
9. Secure FO apparatus on ring stand with clamps.
10. Rinse the stirring rods with DI water, place them inside the cell, and attach them to the motors
11. Fill up two containers; one should contain DI water and the other NaCl solution.
12. Empty the solutions into their respective cells; pour DI slightly sooner than NaCl as to not compromise membrane.
13. Fill the DI cell until it reaches a height of 11.5″ on the column (˜1025 ml), and fill the NaCl cell to a height of 3.5″ (˜600 ml). Record exact heights in the laboratory record book.
14. Turn on the stirring rods to achieve non-turbulent, steady mixing.
15. Sample and measure initial salinity of DI water and NaCl solution.
   a. Measure salinity of DI sample first to avoid salt contamination.
   b. Using a Drummond Scientific Co. pipettor and 10 mL pipette, remove ˜10 mL sample and place in glass vial.
   c. Place the vial with DI in the vial stand, and insert salinity meter. Take and record five (5) salinity readings, and record an average reading. All data should be recorded in respective laboratory book.
   d. Empty vial containing DI back into the DI cell, and proceed to measure salinity of NaCl solution. Empty the vial containing NaCl solution back into the NaCl cell when finished.
16. Take salinity and volume height readings after 2, 4, 6, and 24 hours of operation.
17. To end the test, shut off the stir motors, remove stirring rods, and remove apparatus from ring stands. Empty contents of cells down the sink drain.
18. Loosen coupling with strap wrench to separate DI and NaCl cells.
19. Remove membrane. Do not touch membrane with ungloved hand.
20. Blot membrane with a Kimwipe to remove excess water.
21. Weigh membrane to three decimal places on same analytical balance. Record this weight as used weight (wet) in the laboratory book.
22. Allow membrane to dry in a paper cup, using a vacuum over if necessary. After 24-48 hours have passed, weigh membrane to three decimal places on same analytical balance. Record this weight as used weight (dry) in the laboratory book.
23. Before leaving testing area, ensure that all water spills are wiped up and that all supplies and equipment are put away.

### Standard Operating Procedure (SOP)

### Testing of Reverse Osmosis Membranes

### Scope/Purpose

Reverse Osmosis (RO) membranes operate by using high pressure pumps to reverse naturally occurring osmotic pressure to remove contaminants in a permeate solution from a filtrate. In this testing, salt will be removed from a saltwater mixture (filtrate). Experimentation will be benchmarking commercial membranes, as well as testing the disclosed membranes, in the fabricated RO system with the intention of developing a superior RO membrane.

### Materials

1. Membrane to be tested. It should be noted that RO membranes are stored dry, unlike the Forward Osmosis (FO) membranes that need to be stored wet.
2. RO test platform including: pump, AC drive, plumbing, membrane cell, pressure gauge assemblies, and tanks for feed and permeate collection. Do not unplug AC drive from the wall in order to avoid resetting drive parameters; only disconnect power connection between the pump and motor, if necessary.
3. Membrane Log Book and Laboratory Record Book
4. RO membrane template
5. Razor blade
6. Sampling equipment

a. Syringe with Tygon® tubing

b. Glass vial (×2)

c. Vial stand

d. Salinity meter

### Procedure

1. Obtain membrane to be tested and create entry in Membrane Log Book. The entry should include the following:
   a. Names of the people running the test.
   b. Date that the test was run.
   c. Operating System: RO
   d. Membrane identification information (either name of membrane or identification number if running a Battelle made membrane).
2. Charge the accumulator to 50 percent the maximum system operating pressure (e.g., if the membrane specifies an operating pressure of 800 psi, charge the accumulator to 400 psi). Use the provided charging kit, and never charge the accumulator with oxygen. Use only an inert, non-combustible gas; pure nitrogen is preferred.
3. Cut membrane to correct dimensions using membrane template and razor blade to achieve precise fit when placing membrane in cell. Use gloved hands when handling membranes.
4. Weigh membrane to three decimal places on an analytical balance, and record this value as new weight (dry) in the laboratory book.
5. Remove nuts and upper portion of RO cell to expose membrane slot. Place membrane in cell, ensuring the holes punched in the membrane fit around the posts in the RO cell.
6. Replace top of cell. Hand-tighten each nut with roughly the same torque. Do not over tighten to ensure a secure O-ring seal.
7. Ensure the feed tank is at least half full and filled with the correct salt-water concentration that is required for that particular test. The percentage of salt in the salt-water mixture will change from test to test.
8. Check that all valves (with the exception of the T handled bleed line valve) are completely open both upstream and downstream of cell. Check and secure all safety shields.
9. On pump drive, press START/RUN. Once pump has started, press the up/down arrow on the drive to set the desired frequency. Once frequency has been dialed in and pressure gauges read a steady (low or 0 psi) pressure, slowly close the valve downstream from the cell until the pressure reads 200 psi. Once 200 psi has been reached, allow a few minutes for the system to reach steady state, and check system for leaks.
10. If all systems are operating as they should, again slowly close the downstream valve until the gauge reads the desired pressure. A bleed line with corresponding needle valve, located prior to the incoming stream's pressure gauge, is installed as a means for pressure adjustment. The bleed line valve should only be used if the downstream pressure valve is not able to regulate the system pressure; otherwise, the valve is to remain closed.
11. Allow system to run, sampling feed tank and permeate collection tank at the frequency specified for that test run (e.g., 30 minutes). To sample:
   a. Remove cap from feed tank.
   b. Using syringe with Tygon® tubing, remove ˜10 mL sample, and place in glass vial.
   c. Remove cap from permeate collection container.
   d. Using syringe with Tygon® tubing, remove ˜10 mL sample, and place in a second glass vial.
   e. One at a time, place the vial in the vial stand, and insert salinity meter. Take five (5) salinity readings, and average the readings.
   f. Record all sample data in attached spreadsheet, including the time that the sample was taken.
   g. Empty vial containing feed salt water mixture back into the feed tank, and empty the vial containing permeate into the permeate collection container.
12. When samples are taken, note the pressure that the system is running at. If pressure changes more than 50 psi, make adjustments using the downstream valve to maintain the specified pressure.
13. After system has been run for the specified duration for the test (e.g., 8 hours), take final salinity samples before shutting down system.
14. To shut down system, open downstream valve fully and allow pressure to decrease to 0 psi.
15. When pressures have fully dissipated, loosen nuts from RO cell as well as upper portion of cell.
16. Remove membrane. Do not touch membrane with ungloved hand.
17. Wipe membrane with a Kimwipe to remove excess water.
18. Weigh membrane to three decimal places. Record this weight as used weight (wet) in the laboratory book.
19. Replace top of cell and tighten nuts.
20. Before leaving testing area, ensure that all water spills are wiped up, all valves on RO system are fully open, and the pump is not running. Replace all safety shields.
21. Allow membrane to dry in a paper cup. After 24 hours have passed, weigh membrane to three decimal places. Record this weight as used weight (dry) in the laboratory book.

### CDH45 Salinity Meter

The CDH45 from Omega is a portable hand held digital salinity meter, which displays the salinity of water in percentage (%) along with temperature. The CDH45 is designed for low-concentration salinity measurement. This is based on a principal that salt water conducts electricity much more easily than pure water and hence the salinity content of water can be calculated based on the electrical conductivity measurement. It has a probe (a pair of electrodes, which measures the electrical conductivity of water at a given temperature. Then it uses an in-built conversion table (factor) in order to convert the conductivity data into salinity data in % mass of the dissolved solid. It also automatically uses a temperature compensation factor, which accounts for the changes in conductivity with temperature.

### Relative Salinity

### Range: 0.1 to 10%

Temperature Compensation: −5° to 60° C. (23° to 140° F.), automatic

### Accuracy:

0 to 0.9% (±0.1)
1.0 to 1.9% (±0.2)
2.0 to 2.9% (±0.3)
3.0 to 4.9% (±0.5)
5.0 to 7.9% (±1.0)
8.0 to 10.0% (±1.5, depending on measuring technique)

### Calibration

Calibration information is not provided in the instruction manual. Indirect method of calibration was used to calibrate the salinity meter. It was done by measuring a series of known concentration (salinity) NaCl solutions (in DI water) with the salinity meter and recording the data and its deviation (if any). The calibration data is tabulated below (Table 2):

TABLE 2
Calibration of the Salinity Meter.

| NaCl conc. | Salinity meter used for RO experiments | | |
|---|---|---|---|
| (%, w/v) | Date of Testing | Temp. (° C.) | Salinity Reading (%) |
| 0 | March 2, 2011 | 23.5 | 0.0 |
| 0.05 | March 2, 2011 | 24.4 | 0.0 |
| 0.10 | March 2, 2011 | 24.3 | 0.1 |
| 0.20 | March 2, 2011 | 24.5 | 0.2 |
| 0.60 | February 22, 2011 | 22.5 | 0.6 |
| 2.00 | February 22, 2011 | 22.5 | 1.8 |
| 3.50 | February 22, 2011 | 22.4 | 3.1 |

### EXAMPLES

### Example 1

### Water-Sensitive Nitrogen Containing Polymers with Anionic or Nonionic Polymers in FO Membrane Formulations

The FO membrane formulation compositions for Example 1 are described in Table 3 and their FO testing results are shown in Table 4.

TABLE 3
Formulations for Example I

| | Water Sensitive | Cross- | Anionic or | |
|---|---|---|---|---|
| | Nitrogen Con- | linking | Nonionic Water | |
| | taining Polymers | Modifier | Soluble Polymers | Solvents |
| Samples | (amounts) | (amounts) | (amounts) | (amount) |
| 1 | Elvamide 8061 | Epoxy | PAA (1 g) | DMSO (3 g) |
| | (6 g) | Resin 820 | Polysciences, | Methanol |
| | DuPont | (0.6 g) | Inc. | (27 g) |
| | | DOW | 450,000 Mwt. | Trichloro- |
| | | | | ethylene |
| | | | | (27 g) |
| 2 | Elvamide 8061 | Epoxy | PVP (3.12 g) | DMSO (3 g) |
| | (6 g) | Resin 820 | Aldrich | Methanol |
| | DuPont | (0.6 g) | 29,000 Mwt. | (27 g) |
| | | DOW | | Trichloro- |
| | | | | ethylene |
| | | | | (27 g) |

TABLE 4
FO Testing Results for Samples 1 and 2 of Example 1.

| | Total Volume Change in | % Salt Detected in |
|---|---|---|
| | the DI water Side of the | the DI Water Side of the |
| Samples | Test Cell in 24 Hours | Membrane |
| 1 | 1 | 0 |
| 2 | 4 | 0 |
| Prior Art Control | 1.5 | 0.2 |
| (100% CA) | | |

### Example 2

### Prior Art Water-Sensitive Oxygen Containing Polymers in FO Membrane Formulations

The FO membrane formulation compositions for Example 2 are shown in Table 5 and their FO testing results are shown in Table 6.

TABLE 5
Formulations for Example 2 (Prior Art Membrane Controls).

| | Water sensitive Oxygen | |
|---|---|---|
| | Containing Polymers | Solvents |
| Samples | (amounts) | (amounts) |
| 1 | CA (1.89 g)(100%) | Dioxane (26 ml) |
| | Aldrich | Acetone (9.2 ml) |
| | | Methanol (4.1 ml) |
| | | Acid (3.15 ml) |
| 2 | CTA (1.89 g)(100%) | Dioxane (26 ml) |
| | Aldrich | Acetone (9.2 ml) |
| | | Methanol (4.1 ml) |
| | | Acid (3.15 ml) |
| 3 | CA (0.75 g)(75%) | Dioxane (26 ml) |
| | CTA (0.25 g)(25%) | Acetone (9.2 ml) |
| | | Methanol (4.1 ml) |
| | | Acid (3.15 ml) |
| 4 | CA (8.1 g)(90%) | Dioxane (26 ml) |
| | CAB (0.88 g)(10%) | Acetone (9.2 ml) |
| | Aldrich | Methanol (4.1 ml) |
| | | Acid (3.15 ml) |
| 5 | CTA (6.91 g)(100%) | NMP (31 g) |
| | | Acetone (2.51 g) |
| 6 | CA (8.4 g)(100%) | Dioxane (27.6 ml) |
| | | NMP/Acetone (10.25 ml) |
| | | Methanol (3.6 ml) |
| | | Acid/(2.1 ml) |

TABLE 6
FO Testing Results for Samples 1 through 6 of Example 2.

| | Total Volume Change in | % Salt Detected in |
|---|---|---|
| | The DI Water side of | the DI Water Side of |
| Samples | the Test Cell | the Membrane |
| 1 | 2 | 0.15 |
| 2 | 7 | 0.1 |
| 3 | 2.9 | 0.2 |
| 4 | 1 | 0.1 |
| 5 | 5 | 0.4 |
| 6 | 2.9 | 0.4 |

### Example 3

### FO Test Results for Commercial Membranes and a Membrane of this Disclosure

### The FO Test Results are Shown in Table 7

TABLE 7
FO Test Results.

| | Amount of DI Water Passing | % Salt |
|---|---|---|
| Commercial Membranes | Through the Membrane into | Detected in |
| and a Example of | the Salt Solution in | the DI Side of |
| this Disclosure | 24 Hours (Flux) | the Membrane |
| Toray TM800S | 1.4 | 0 |
| DOW XL | 0.3 | 0 |
| Nitto Denko SWC5 | 0.8 | 0 |
| GE-AD | 0.8 | 0 |
| DOW HR | 1.2 | 0 |
| HTI-NW (Hydration | 4 | 0 |
| Technology | | |
| Innovations) | | |
| 5% Nylon/95% | 5.5 | 0 |
| PVOAC | | |
| This Disclosure | | |

### Example 4

### Comparison of Novel Membranes with Commercial FO and RO Membranes

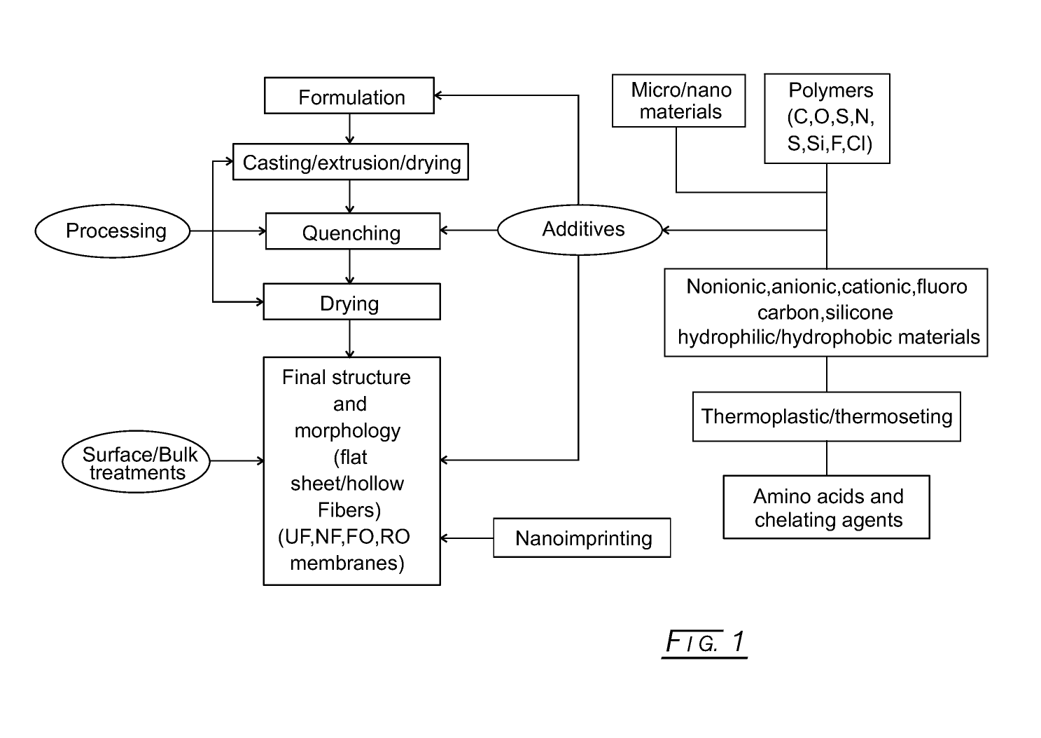

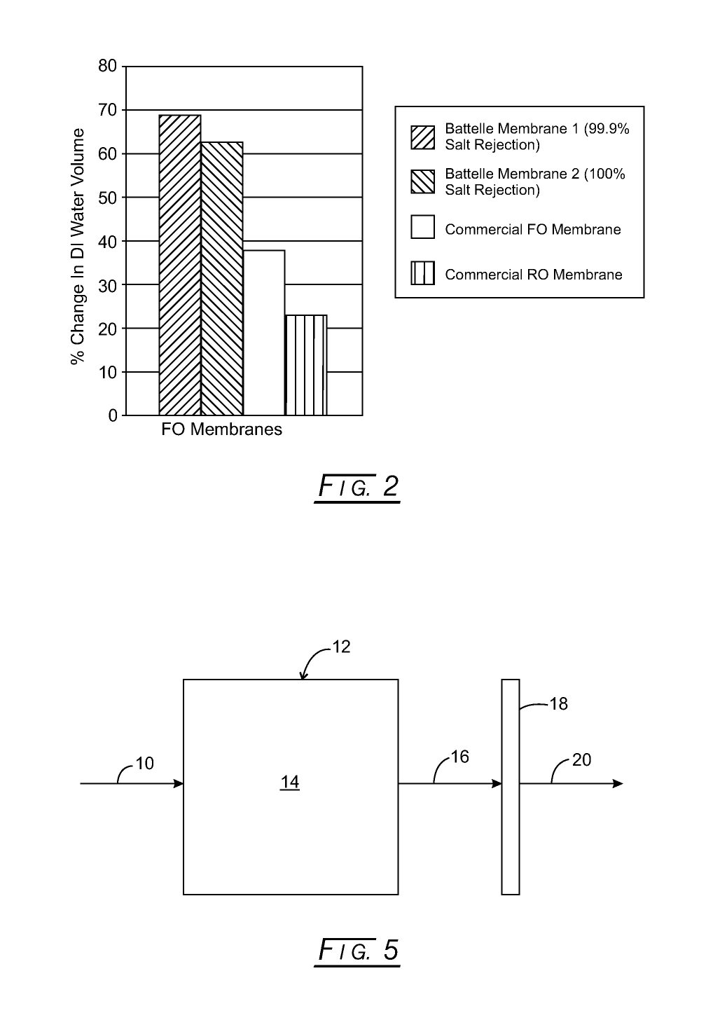

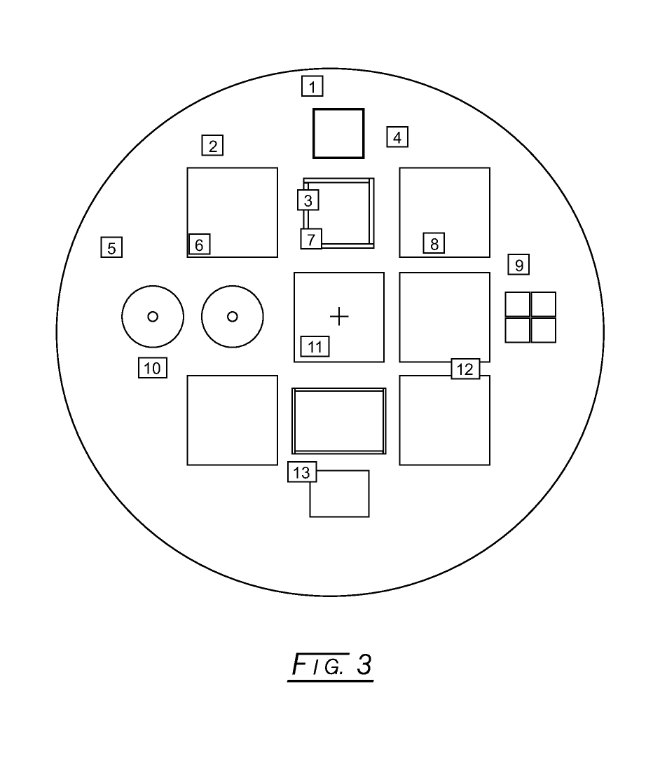

The starting column height for DI water is 11.5 inches. From the graph (FIG. 1) (Battelle Membrane) 68 percent change occurred in 24 hours then (11.5*0.68=7.82 inches) 7.82 inches of column height passed through the membrane. A two-inch inside diameter gasket is used to hold membrane in fixture and that value was used to calculate the area of active membrane (Table 8).

TABLE 8
Calculations for % Volume Change of the DI Water Side of the Membranes.

| | From | Start | Inches of | | | Membrane | Membrane |
|---|---|---|---|---|---|---|---|
| | graph | DI | DI Water | Diameter | Volume | Area | Area |
| | % | Water | Passes | of Tube | Water | (2″ diam) | (2″ diam) |
| Color Bar | Change | Height | Through | (in) | (cc) | in² | ft² |
| Battelle | 68 | 11.5 | 7.82 | 2.00 | 158.4 | 3.14 | 0.021806 |
| Membrane 1 | | | | | | | |
| Battelle | 63 | 11.5 | 7.25 | 2.00 | 146.8 | 3.14 | 0.021806 |
| Membrane 2 | | | | | | | |
| Commercial | 38 | 11.5 | 4.37 | 2.00 | 88.5 | 3.14 | 0.021806 |
| FO | | | | | | | |
| Membrane | | | | | | | |
| Commercial | 23 | 11.5 | 2.65 | 2.00 | 53.6 | 3.14 | 0.021806 |
| RO | | | | | | | |
| Membrane | | | | | | | |

The disclosed membranes were 1 and 5 percent Nylon to 99 to 95 percent CA (Battelle Membranes) (99.9 to 100 percent salt rejection), while the unhatched bar was an HTI FO membrane and hatched RO bar was a DOW XL RO membrane. Both commercial membranes had no signs of salt detection in the DI waterside of the membrane.

### Example 5

### FO Testing Results for Prior Art Membranes and the Membranes of this Disclosure

The membrane compositions and FO testing results are shown in a combined Tables 9 and 10.

TABLES 9 and 10 combined
Comparison of Flux and Salt Rejection for
Various Amide/Cellulose Acetate (CA)/Cellulose
Triacetate (CTA) FO Membrane Formulations

| | | | Relative Flux |
|---|---|---|---|
| | | | Change in DI Water |
| | | % Salt | Side Column Height |
| Sample | System | Rejection | (in.) |
| 1 | 100% CTA | 90-95 | 8 |
| 2 | 100% CA | 90-95 | 2 |
| 3 | 5% CTA/95% CA | 90-95 | 3 |
| 4 | 12% CTA/88% CA | 90-95 | 3.5 |
| 5 | 25% CTA/75% CA | 90-95 | 2.5 |
| 6 | 10% Nylon/90% CA | 99 | 2 |
| 7 | 25% Nylon/75% CA | 99 | 4 |
| 8 | 50% Nylon/50% CA | 99 | 2 |
| 9 | 2% Nylon/98% CTA | 99 | 5 |
| 10 | 4% Nylon/96% CTA | 99 | 3 |
| 11 | 15% Nylon/85% CTA | 99 | 2 |
| 12 | 5% Nylon/95% PVOAC | 99 | 6 |
| 13 | 10% Nylon/90% CA/Mesh | 99 | 0.5-1 |

Nylon = ELVAMIDE 8061
PVOAC = Polyvinyl Acetate (9003-20-7 MW-100,000 Aldrich)
Test was run in the static FO test cell

For example, prior art samples 1 through 5 have undesirable salt rejection or salinity readings in the DI water side of the membrane of 90 to 95 percent and total DI water transfer volumes of 2 to 8. Control samples 6 to 12 all have salt rejection values of at least 99% volume changes of between 2 and 6. Samples 6 through 11 of this disclosure (combinations of water-sensitive Nylons with water-sensitive CA/CTA polymers) have no signs of salt transfer to the DI waterside of the cell and DI water volume changes of 2 to 5. Sample 12 of this disclosure (combination of a water-sensitive Nylon with a water-sensitive nonionic polyvinyl acetate) had no signs of salt transfer to the DI water and a DI volume change of 5. Sample 13 is the same composition as 6, but was laminated with a polyester mesh for strength. The salt back transfer again was 0 or at least 99+% percent salt rejection but the change in DI volume was restricted to 0.5-1 from 2.

These results demonstrate the ability to significantly control the salt transfer properties of the blends of this disclosure over the control prior art membranes under the same experimental conditions.

### Example 6

### RO Testing of Commercial Membranes and Membranes of this Disclosure

Table 11 shows the results of RO testing for several commercial RO membranes with membranes of this disclosure.

Other Considerations—As part of this disclosure it was discovered that sulfonated polymers can be reacted with amines to make amides which can be used to control the flux, water wettability, salt rejection and antifouling properties of a membrane.

TABLE 11
RO Test Results.

| | Amount of Water Passing | % Salt Detected |
|---|---|---|
| Commercial Membranes | Through the Membrane | in the Water |
| and Examples of | from the Salt Solution | (Permeate) Side |
| this Disclosure | in 3 Hours (Flux) (ml/min) | of the Membrane |
| Toray | 1.68 | 2.6 |
| DOW XL | 3.93 | 1.3 |
| Nitto Denko | 1.55 | 0.6 |
| GE-AD | 0.93 | 0.8 |
| DOW SW30 HR | 2.14 | 1.02 |
| HTI | 0.39 | 0.6 |
| 5% Nylon/94% CA/1% | 1.35 | 2.8 |
| Polyvinylalcohol on a | | |
| Polysulfone Support | | |
| Composite Membrane | | |
| 5% Nylon/95% Polyvinyl | 0.3 | 1.6 |
| Acetate/Nafion Laminate | | |
| 5% Nylon/95% CA/ | 1.21 | 3.1 |
| Sulfonated Polysulfone | | |
| (U.S. 2009/0111027 A1; | | |
| U.S. 2009/0061277 A1; | | |
| U.S. 2007/0163951 A1) | | |
| Laminates | | |

TABLE 11
RO Test Results.

| | Amount of Water Passing | % Salt Detected |
|---|---|---|
| Commercial Membranes | Through the Membrane | in the Water |
| and Examples of | from the Salt Solution | (Permeate) Side |
| this Disclosure | in 3 Hours (Flux) (ml/min) | of the Membrane |
| Toray | 1.68 | 2.6 |
| DOW XL | 3.93 | 1.3 |
| Nitto Denko | 1.55 | 0.6 |
| GE-AD | 0.93 | 0.8 |
| DOW SW30 HR | 2.14 | 1.02 |
| HTI | 0.39 | 0.6 |
| 5% Nylon/94% CA/1% | 1.35 | 2.8 |
| Polyvinylalcohol on a | | |
| Polysulfone Support | | |
| Composite Membrane | | |
| 5% Nylon/95% Polyvinyl | 0.3 | 1.6 |
| Acetate/Nafion Laminate | | |
| 5% Nylon/95% CA/ | 1.21 | 3.1 |
| Sulfonated Polysulfone | | |
| (U.S. 2009/0111027 A1; | | |
| U.S. 2009/0061277 A1; | | |
| U.S. 2007/0163951 A1) | | |
| Laminates | | |

### Example 7

### Performance Data

Historically, cellulose-based membranes were used for water desalination. Table 12 compares the performance of FO membranes (CTA and CTA/Polyamide or Nylon, where the Polyamide is ELVAMIDE 8061 DuPont) is a secondary polymer additive) with commercial FO membranes (HTI-NW and HTI-SS). The flux and salt rejection are in a comparable range, under the same testing conditions. It is noteworthy that the addition of a Polyamide polymer to the CTA membrane considerably increases the flux, without affecting the salt rejection. The performance of NF membranes can be enhanced by incorporation of a secondary polymer (Thermosetting Epoxy/Amine) system, where the flux increased almost four times, with a small increase in a salt rejection.

TABLE 12
Comparison of Flux and Salt Rejection
of Disclosed and Commercial Membranes

| | | | Flux | % Salt |
|---|---|---|---|---|
| # | Membrane | Description | [LMH] | Rejection |
| 1 | HTI-NW | FO Commercial Control | 4.31 | 99.91 |
| | | Flow: 1.0 LPM (DI) and | | |
| | | 0.25 LPM (salt) | | |
| 2 | HTI-SS | FO Commercial Control | 4.14 | 99.79 |
| | | Flow: 1.0 LPM (DI) and | | |
| | | 0.25 LPM (salt) | | |
| 3 | CTA/Poly- | Battelle CTA membrane | 2.64 | 99.81 |
| | amide/Nylon | with 1-2% polymer | | |
| | EIVAMIDE 8061 | ELVAMIDE 8061 Flow: | | |
| | | 1.0 LPM (DI) | | |
| | | and 0.25 LPM (salt) | | |
| 4 | CTA | Battelle CTA membrane | 0.44 | 99.89 |
| | | Flow: 0.35 LPM on DI and | | |
| | | salt side | | |
| | CTA/ | Battelle CTA membrane | 3.27 | 99.82 |
| | EIVAMIDE 8061 | with 1-2% polymer | | |
| | | ELVAMIDE | | |
| 5 | | 8061 Flow: 0.35 LPM on | | |
| | | DI and salt side | | |
| 6 | PS Base | NF Commercial Control | 8.38 | 99.92 |
| | (Polysulfone | Flow: 1.0 LPM (DI) and | | |
| | Sepro PS 35) | 0.25 LPM (salt) | | |
| 7 | PS | NF PS Base with 1% | 31.5 | 99.99 |
| | Base/Epoxy/ | Battelle's polymer | | |
| | Amine | Epoxy/Amine | | |
| | | Flow: 1.0 LPM (DI) and | | |
| | | 0.25 LPM (salt) | | |

These particular water transport (flux) and salt rejection studies were carried out on a dynamic FO test apparatus where the membrane flow cell holder was a modified RO test cell which was fitted with two low flow rate peristaltic pump systems. Both the DI water flow rates across the membrane face and the draw solution (3.5 to 6% salt water) flow rates on the other side of the membrane could be adjusted to have equal flows across each side of the membrane or different flows across the two membrane sides. Table 13 describes the salt rejection and flux results for membranes run under Battelle's relatively low equal flow rates on both sides of the membrane and membranes run at very high equal flow rates on each side of the membranes at the Colorado School of Mines (CSM) test facility (Golden Colo.)

TABLE 13
Membrane Flux/Salt Rejection Values at Different
Flow Rate Test Cell Conditions

| | Flow Rates | | |
|---|---|---|---|
| | Liters Per | Flux [Liters/ | Salt |
| | Minutes | Meters²/Hours] | Rejection |
| Membranes | (LPM) | (LMH) | (%) |
| Novel | 0.25 | 3 | 99.75 |
| HTI-NW | 0.25 | 4 | 99.82 |
| HTI-SS | 0.25 | 3 | 99.65 |
| Novel | 0.35 | 3 | 99.76 |
| HTI-NW | 0.35 | 3.9 | 99.90 |
| HTI-SS | 0.35 | 3 | 99.80 |
| Novel | 1.5 (CSM) | 8 | 99.98 |
| HTI-NW | 1.5 (CSM) | 4.5 | 99.99 |
| HTI-SS | 1.5 (CSM) | 7.5 | 99.95 |

### Fouling Studies

### Example 8

### Polymers

The first set of commercial RO membranes (Hydranautics 84200.SWC5J) were obtained from Nitto Denko Corp. and exposed to a commercial DuPont grout Sealer that contained a hydrophobic fluoropolymer (fluorinated acrylic copolymer) at 1% solids in propylene glycol monobutyl ether. The membranes were soaked with the grout sealer for 120 seconds at room temperature and air knifed to remove the excess solvent. These samples were then allowed to air-dry overnight to finalize the membrane modification process.

A second set of Nitto Denko membranes were coated with Olympic Water Guard waterproofing (hydrophobic) sealant (12% solids) [water acrylic resin (25035-69-2); polysiloxane (71750-80-6) and ethylene glycol (107-21-1)] which was diluted with DI water to form 1% and 5% solutions. These solutions were applied to the membranes and dried in an identical manner as the DuPont grout modified samples.

All three duplicate sets of RO membrane coated samples (DuPont grout—samples A, B; 1% and 5% Olympic Water Guard—samples B, C and D, E respectively) and their untreated controls (samples F and G) were sent to Battelle's Florida Marine Research Center (FMRC) where they were placed on holding racks and lowered into the Halifax River for 14 days of exposure testing to the very active marine fouling environment.

The 1% grout (samples A and B) and the Olympic coatings (1% and 5%) samples B, C, D, and E showed little or no signs of fouling (attachment of bioorganisms hydroids) while the untreated control samples F and G were completely covered with biological growth organisms.

Modification of the grout and the Olympic coatings to contain nonionic and cationic or zwitterionic polymers were also investigated in this example. Various amounts of these types of polymers were added to either the grout or Olympic coatings and the results of these studies on the Nitto Denko membranes are shown in Table 14.

TABLE 14
Different Polymers

| | DuPont Grout | Olympic | Nonionic Polymer | Ionic Polymer |
|---|---|---|---|---|
| System | (%) | (%) | (%) | (%) |
| 1 | (1) | — | — | — |
| 2 | — | (5) | — | — |
| 3 | — | — | (5)P1 | — |
| 4 | — | — | — | (5)P2 |
| 5 | (0.5) | — | (0.5)P1 | — |
| 6 | (0.5) | — | — | (0.5)P2 |
| 7 | — | (2.5) | (2.5)P1 | — |
| 8 | — | (2.5) | — | (2.5)P2 |
| 9 | — | (2.5) | (1)P1 | (1.5)P2 |
| 10 | — | (2.5) | (2.5)P3 | — |
| 11 | — | (2.5) | — | (2.5)P4 |
| 12 | — | — | — | — |

P1 = Polyvinylpyrrolidone (9003-39-8)
P2 = Polyquaternium-2 (68555-36-2)
P3 = Polypropylene glycol diol (25322-69-4)
P4 = a mixture of P2, dopamine hydrochloride (62-31-7) and betaine hydrochloride zwitterion (590-46-5) [0.83% each respectively]

The Florida immersion tests were run for 28 days and the order of least fouling to highest fouling was as follows:

Systems 9 and 11 (excellent—no sign of bioorganisms/films); Systems 5, 6, 7, 8, 10 (very good—1 to 3% growth coverage); Systems 1, 2, 3, 4 (good—3-5% growth on sample surface); system 12 (untreated control) unsatisfactory—30 to 100% of the surface was covered with biofilms or organisms that could not be removed with a water wash rinse.

### Example 9

### Polymers and Processing

A cellulose triacetate (CTA)/nylon/polyamide type polymer (ELVAMIDE 8061) blend in dioxane was prepared as previously described in Example 7 of this application. The normal way of processing these types of polymer blends into membranes is to allow the solvent to evaporate over a specified time period (short times—seconds to a few minutes for ultra and nanofiltration membranes); longer time periods (3 to 5 minutes) for FO membranes and even longer times (5 to 30 minutes) for RO membranes followed by immediate quenching in a water bath to lock in their morphological features that control the final flux and salt rejection properties of the membrane.

In this particular example different polymer materials were added at a 5% level to the water quench bath before immersing the polymer blend into it to create the final structure. The addition of different polymers in the quench bath interacted in a unique manner with the CA/nylon blend and created new composite polymer structures that could not be obtained by any other method.

These new composite polymer membranes had different flux capacities and excellent fouling resistance capabilities than their unmodified control membrane counterparts.

The results of these new polymer modified membranes and their transport properties are shown in Table 15.

TABLE 15
Polymer Quenching Studies.

| | | | Fouling Resistance |
|---|---|---|---|
| System | Formulation | Properties | After 14 Days Immersion |
| 1 | Normal (control) | Flux = 1 | Fully Fouled (100% of the |
| | formation of a | Salt Rejection = 97% | sample was covered with |
| | CTA/Nylon membrane | | biofilms or organisms) |
| | (no polymers added to | | |
| | the water quench bath) | | |
| 2 | Same as system 1 | Flux = 1.2-1.5 | Very Good Resistance (1- |
| | except 5% P1 was | Salt Rejection = 97% | 3% of the sample was |
| | added to the water | | covered with |
| | quench bath | | biofilms/bioorganisms) |
| 3 | Same as system 1 | Flux = 1.2-1.5 | Very Good Resistance (1- |
| | except 5% P1 was | Salt Rejection = 97% | 3% of the sample was |
| | added to the water | | covered with |
| | quench bath | | biofilms/bioorganisms) |
| | but 5% P2 was | | |
| | added to the water | | |
| | quench bath | | |
| 4 | Same as system 1 | Flux = 1.2-1.5 | Excellent (no signs of |
| | except 5% P1 was | Salt Rejection = 97% | growth) |
| | added to the water | | |
| | quench bath | | |
| | but 2.5% P1/2.5% P2 | | |
| | added to quench bath | | |
| 5 | 2.5% P1 and 2.5% P2 | Flux = 1 | 30 to 50% of the sample |
| | blended with CTA/Nylon′ | Salt Rejection = 95% | was covered with a biofilm |
| | dissolved in dioxane and | | |
| | water quenched with | | |
| | water that contained no | | |
| | water soluble or | | |
| | dispersible polymers | | |

### Example 10

### Polymers and Processing

One of the major problems in treating or coating preformed membrane structures for flux enhancement, salt rejection or fouling resistance is to not block the pore structures of the membrane during the coating or treatment process. Application of a high solids coating formulation can fill the pores of the membrane resulting in a significant decrease in the ability of the membrane to transport fluids through its structure (decrease in flux). We have found that a vacuum or forced air assist coating process that drives the coating and air through the pores of the membrane is very beneficial in just coating the membrane surfaces without filling or blocking the pores of the membrane. This special coating process leaves the desired treatment systems on the surface of the membrane without blocking/filling the pores and significantly decreasing the original flux capacity of the membrane.

Results for different coating processes to create fouling resistant hydrophobic surfaces on filtration membrane structures while maintaining their flux properties are shown in Table 16.

TABLE 16
Hydrophobic Polymer Modifications
of Sepro Filtration Membranes.

| | | Water Drop | |
|---|---|---|---|
| Support | Treatment | Contact Angle | Relative |
| Membrane | System | (degrees) | Flux |
| Sepro PS35 | None | 73 | 1 |
| | (as received) | | |
| ″ | Soaked with a 1% Du Pont | 112 | 0.8 |
| | grout sealer (hydrophobic | | |
| | acrylic fluoro copolymer) | | |
| | solution and air dried Ibid | | |
| | but vacuum assist to pull | | |
| | the wet coating solution through | | |
| | the pores of the membrane | | |
| ″ | Soaked with a 1% Du Pont | 111 | 1 |
| | grout sealer (hydrophobic | | |
| | acrylic fluoro copolymer) | | |
| | solution and air dried Ibid | | |
| | but vacuum assist to pull | | |
| | the wet coating solution through | | |
| | the pores of the membrane | | |
| | but vacuum assist to pull the | | |
| | wet coating through the pores | | |
| | of the membrane with continual | | |
| | air flow followed by drying | | |
| Sepro PS10 | None (as received) | 51 | 1 |
| ″ | Soaked with a 1% Du Pont | 112 | 0.8 |
| | grout solution and air dried | | |
| ″ | Soaked with a 1% Du Pont | 112 | 1 |
| | grout solution and air dried | | |
| | but vacuum assist to force | | |
| | the coating through the | | |
| | membrane pores and force air | | |
| | dried | | |

### Example 11

### Roll-to-Roll Nanoimprint Lithography (R2RNIL) Polymers and Processing

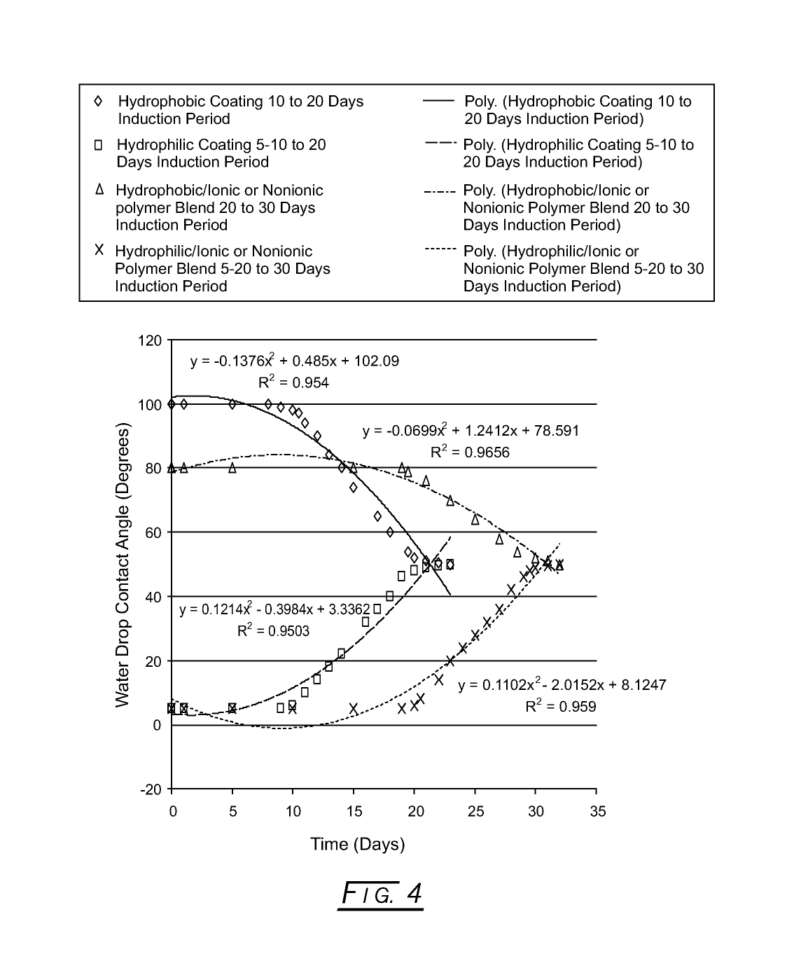

The primary features of this disclosure are to produce micro and nanostructure patterns on continuous polymer films or membrane surfaces using a roll-to-roll nanoimprint lithographic [R2RNIL] process. The methods used to create this technology are described as follows:
1) Take a 4-inch silicon wafer substrate and using photolithographic techniques produce thirteen different patterns on the surface of the wafer as shown in FIG. 4.
2) A silicone polymer (RTV) is cast over the patterned wafer surface to create a replica surface.
3) A thermoformed polyurethane coating is cast over the silicone polymer replicate which is then cured and removed from the silicone polymer replica and electroplated with nickel to form the hard embossing micro or nano patterned plate substrate.
4) The nickel embossing plate is attached to a roller on a roll-to-roll mill and different polymer or membrane films are pressed through the embossing plate to create the nanoimprint structures on the surfaces of the polymers and membranes in a continuous manner.

### FIG. 4. Test Pattern.

Silica on Silicon Wafers
Typically ˜3 mm of silica on silicon substrate that is either ½ or ¼mm thick

13 test patterns, see diagram on right for label

Target Etch Depths vary according to pattern
Patterns 1, 2, 3, 4, 5, 6: 5-10 mm
Patterns 7, 8: 10-50 mm (deep)
Patterns 9, 10, 12: 0.5-2.0 mm (shallow)
Patterns 11 and 13: anywhere from 0.5-10 mm
Thirteen patterns were embossed onto a polycarbonate film and the films with no patterns had water drop contact angles of between 77°-79°, while patterns 5, 6, and 13 had contact angles of 94°-105°, 90°-98°, and 114°-116°, respectively. The embossed films were placed in a biologically active natural seawater container and allowed to stay in contact with the water for 56 days. Analysis of the biofilms on the patterns showed high growth on patterns 2, 3, 5, 6, 10, and 11 while patterns 1, 4, 7, 8, 9, and 13 had medium growth but pattern 12 had low biofilm growth on its surface. The biofilms on the patterns were stained with Cyto-9 and Propidium Iodide and live cells were green and empty spaces showed no signs of growth. The amount of biofouling was determined by visual examination using a Olympus Confocal Microscope.
The addition of swimming pool clarifiers (Nature Works LLC Clarifier) or biocides to the polymer before embossing greatly reduces the ability of a biofilm to form.
The nickel embossing plate was pressed into a Nitto Denko RO membrane active surface and created the 13 different patterns on its surface. This embossed membrane was exposed to the FMRC marine environment for 14 days then removed and examined for which patterns resisted the growth of a biofilm structure. Almost all of the patterns showed some form of growth except for patterns 10 and 13.
These pattern studies show the potential for enhanced surface protection of a membrane from fouling but need to be combined with the right balance of hydrophobic/hydrophilic or ionic/biocide elements for extended protection over long periods of time as shown in some of the other examples in this patent application.

### Example 12

### Modification of Preformed Membranes

A series of commercial membranes were modified by either a coating or chemical treatment and the resultant change in their surface energies (water drop contact angles) and water transport properties are shown in Table 17.

TABLE 17
Coating/Chemical Treatment Modifications
of Commercial Membranes.

| | | | Water Drop | Salt | |
|---|---|---|---|---|---|
| | | | Contact | Rejec- | |
| Sam- | Support | Coating or | Angle | tion | Flux |
| ple | Membrane | Treatment | (°) | (%) | (GFD) |
| 1 | Sepro PS35 | None | 71 | 98.9 | −0.07 |
| 2 | ″ | ″ | 75 | 98.9 | −0.06 |
| 3 | ″ | DuPont grout | 86.5 | 99 | 0.21 |
| | | sealant | | | |
| 4 | ″ | 1% Epoxy | 88.3 | 97.8 | −0.28 |
| 5 | HTI NW-4 | None | 57.7 | 99 | 3.22 |
| 6 | ″ | DuPont grout | 74.4 | 99 | 3.27 |
| | | sealer | | | |
| 7 | ″ | 1% Epoxy | 60.6 | 99 | 1.65 |
| 8 | HTI ES-1 | None | 68 | 99 | — |
| 9 | ″ | DuPont grout | 79.8 | 99 | — |
| | | Sealer | | | |
| 10 | ″ | 1% Epoxy | 69.3 | 99 | — |
| 11 | Sepro PS35 | 1% sulfuric acid | 70 | — | — |
| 12 | ″ | 2% sulfuric acid | 68 | — | — |
| 13 | ″ | 5% sulfuric acid | 71.5 | — | — |
| 14 | ″ | 10% sulfuric acid | 72 | — | — |
| 15 | ″ | None | — | 98.9 | −0.07 |
| 16 | ″ | 1% Polyacid | — | 99 | 1.5 |
| 17 | Sepro | None | — | 97 | −5 |
| | PAN 400 | | | | |
| 18 | Sepro | 1% Polyacid | — | 95 | −10 |
| | PAN 400 | | | | |

The salt rejection and flux experiments were carried out using the dynamic FO test equipment with 0.3 LPM flow rates on both sides of the membrane and the VWR conductivity meter.

In another dynamic FO experiment where the flow rate was higher on the DI water side (1 LPM) than the salt draw solution side of the membrane (0.3 LPM) the Sepro PS35 untreated control had a flux of 5 GFD while the 1% Epoxy modified Sepro PS35 had a flux rate of 18 GFD. Both systems had 99% salt rejection. Similar results were observed for Sepro PAN 400 treated with 1% Epoxy where the flux was −5 GFD for the untreated control sample but 4.12 GFD for the treated sample.

Combinations of 1% Epoxy and 1% of 0.13 um size Nylon 6 powder (KOBO TR-1, Toray, 3474 S. Clinton Ave., S. Plainfield, N.J. 07090) showed 98% salt rejection and 9.23 GFD flux values.

The Epoxy system used in these experiments was a 50/50 blend of Momentive's water dispersions EPI-REZ Resin 3510-W-60 and EPIKURE Curing Agent 6870-W-53 (EXEL LOGISTICS, Houston Tex.) which were applies at 1% solids coatings in water to the different membrane surfaces and allowed to air dry at room temperature for 2 days before running the dynamic tests.

The 1% Polyacid coating was 1 gm Polyacrylic acid/1800 molecular weight (9003-01-4) (Aldrich), 0.45 gms Cymel 1172 melamine crosslinking oligomer (Cytec), and 0.13 gms para-toluenesulfonic acid catalyst (6192-52-5) (Aldrich) in 98.42 gms water. The membranes were soaked in this solution for 120 seconds and oven cured at 125 C for 1 hour before testing.

### Example 13

### Fouling Models

There are several physical and chemical parameters that influence how fast a biological organism will attach to a polymer or membrane surface. The wetability of a surface (hydrophobic or hydrophilic) is one of the more critical parameters, as is the surface roughness of the polymer/membrane as well.

It is well known that very hydrophobic smooth surfaces, like fluorocarbon and silicone polymers, have very high water drop contact angles and can resist the attack by bioorganisms for very long extended time periods in a marine environment. If, however, these smooth surfaces become roughened or contaminated with dirt then these situations can lower the contact angles and lead to attachment and growth of the bioorganism.

Another set of parameters comes from the chemical nature of the polymer or formulation that makes it hydrophilic or ionic in nature (low water drop contact angles) or if there are chemical reactants like amino acids, dopamine derivatives, quaternary ammonium salts that are actually biocides which decrease the ability of the bioorganism to form a film and grow on the surface of the polymer or membrane exposed to a water source with high bioactivity.

The model proposed that best describes this disclosure is based on the differences between a pure hydrophobic surface, a pure hydrophilic surface, and a surface that contains some form of biocide activity. All of these model surfaces (hydrophobic, hydrophilic, ionic, or contains a biocide), assuming equal surface roughness characteristics, start off with no signs of fouling; but at some point in time an early biofilm growth induction period occurs which continues for a certain period of time, after which strong fouling of the substrate is observed.

With hydrophobic surfaces having contact angles between 90° and 150° and surface roughness values between 1.25 and 4.5 μm arithmetic mean height after static exposure to a marine fouling community start to show signs of decreasing their hydrophobic nature and lowering their contact angle values to between 30° to 70° at which point in time the first signs of biofilm growth appears (induction period). Extended periods of static exposure time for very hydrophobic surfaces but now with contact angels around 50° results in the start of extensive fouling processes.

A similar analogy can be formulated for hydrophilic surfaces with low contact angles of 5°, but over time (induction period) increase to 30° to 70° where the initial biofilms start to grow and continue until strong fouling is observed.

Ionic (nonionic, cationic, zwitterionic, anionic) and systems with biocides combined with either hydrophobic or hydrophilic polymers undergo the same decrease or increase in their contact angle values into the biofilm growth induction period region of 30° to 70° contact angle values for these surfaces but continue to resist attack of the bioorganisms for longer time periods because of the inherent biocide nature of the system.

Table 18 shows the results for a series of commercial RO membrane (Nito Denko SWC5J) structures that were treated with hydrophobic coatings, exposed to 14 days in a marine environment as an example of a postulated biofilm growth model.

TABLE 18
Modification of Membranes and Fouling Results

| | Water Drop | | Surface | |
|---|---|---|---|---|
| | Contact Angle | | Roughness | Relative |
| Sample | (°) | Coating | (μm) | Rating |
| 1A | 94.9 (H) | 1% Olympic | 1.25 (L) | 0.94 |
| 6A | 94.5 (H) | ″ | 1.25 (L) | 0.87 |
| 8B | 90.4 (L) | ″ | 4.75 (H) | 0.81 |
| 12B | 91.5 (L) | ″ | 4.75 (H) | 0.81 |
| 20A | 93.4 (L) | 5% Olympic | 2.25 (L) | 0.94 |
| 25A | 93 (L) | ″ | 2.25 (L) | 0.87 |
| 28B | 97.1 (H) | ″ | 4.25 (H) | 0.75 |
| 31B | 99.1 (H) | ″ | 4.25 (H) | 0.75 |
| 1AA | 152.4 (H) | 1% DuPont grout sealer | 2.25 (L) | 0.87 |
| 8AA | 152.6 (H) | ″ | 2.25 (L) | 0.87 |
| 15B | 120.9 (L) | ″ | 4.25 (H) | 1 |
| 20B | 122.1 (L) | ″ | 4.25 (H) | 1 |
| 25CA | 21 (L) | None | 1.5 (L) | 0 |
| 26CA | 16 (L) | ″ | 1.5 (L) | 0 |
| 27CB | 64 (H) | ″ | 4.75 (H) | 0 |
| 28CB | 63 (H) | ″ | 4.75 (H) | 0 |

A = active side (asymmetric) of the membrane was coated and exposed to the marine environment.
B = backside (support) of the membrane was coated and exposed to the marine environment.
H = high contact angle for each coating treatment and surface roughness value.
L = low contact angle and surface roughness value for each coating treatment.
0 = poor rating; 1 = excellent rating.

All of the coated samples in Table 18 resulted in considerably less fouling than the uncoated controls. As long as the contact angles were above 90° did not matter what the surface roughness values (high or low) were for these systems as the hydrophobic nature of the surfaces controlled the initial biofilm growth process.

The surface roughness values for the 1% Olympic and DuPont grout sealer coatings did influence the lowering of the contact angles from the coated A side to the B coated sides of these membranes. The 5% Olympic coated membranes had a trend more similar to the uncoated control membranes where the A sides (coated and uncoated) had lower surface roughness values and lower contact angle values while the B side coated and uncoated sides had both high surface roughness values and high contact angle values.

Analysis of the data in Table 8 is described as follows:

Relative Fouling Resistance Ranking (A Side Coated Samples)=8.41E³ (Contact Angle)+0.13(% Coating Applied)−0.52 (Surface Roughness)+0.63 R²=0.99

Relative Fouling Resistance Ranking (B Side Coated Samples)=2.16E² (Contact Angle)+9.04E² (% Coating Applied)+1.21 (Surface Roughness)−7.42 R²=0.99

After about a month exposure time the hydrophobic coatings on the membranes started to show signs of biofilm formation resulting from the lowering of their contact angle values.

In another set of fouling experiments, a 98% Cellulose Acetate/2% Nylon (ELVAMIDE 8061) solution in dioxane was divided into 6 samples as described and tested for fouling resistance in Table 19.

TABLE 19
Effect of Additives in the Water Quench Bath on Fouling Resistance

| | | | | % Fouling After 20 |
|---|---|---|---|---|
| | | | Water Quench | Days Exposure at |
| | Cellulose Tri | Evaporation Time | (Time/Temperature/Additives) | Battelle's FMRC |
| System | Acetate(CTA)/Nylon | (minutes) | [Annealing Time/Temperature] | (% Fouled) |
| Control | Cellulose TRI | 2 | (5 min./room temp./none) | 100% |
| | Acetate/Nylon | | [5 min./85° C.] | |
| 1 | Cellulose TRI | ″ | (5 min./room temp./none) | 50 |
| | Acetate/Nylon, | | [5 min./85° C.] | |
| | but added 5% of a | | | |
| | nonionic hydrophilic water | | | |
| | soluble polymer | | | |
| | (polyvinylpyrrolidone | | | |
| | [PVP]) to the system | | | |
| 2 | Same as the control (no | ″ | Added 5% of the PVP to the | 90 |
| | additives) | | water quench bath and | |
| | | | quenched/annealed this system | |
| | | | in the same identical manner | |
| | | | as the Control and System 2 | |
| 3 | Same as the Control but | ″ | Same as the control | 50 |
| | added 2.5% of a cationic | | | |
| | polymer (polyquaternium- | | | |
| | 2) | | | |
| 4 | Same as System 1 but | ″ | Same as the control | 75-80 |
| | added 2.5% of the PVP | | | |
| | and 2.5% of the cationic | | | |
| | polymer | | | |
| 5 | Same as the Control | ″ | Added the same additive | Almost no |
| | (no additive) | | package in System 4 into the | signs of fouling |
| | | | water bath and processed this | |
| | | | system like the Control | |

These results in Table 19 show the improved advantage of incorporation of an additive in the water quench bath as opposed to putting the additives in the casting solution directly.

A general model that helps us understand the ability of different additives to enhance the fouling resistance of a membrane treatment or formulation/additive modification is shown in FIG. 5. The model is based on a unique composition of matter that is a unique combination of hydrophobic or hydrophilic polymeric materials as part of the membrane structure or as a coating/surface treatment on the surface of a preformed membrane. In addition to the hydrophobic/hydrophilic material combinations, there are another set of critical materials required to fit this model. The second set of material/additives required for this are low surface energy water sensitive nonionic, cationic, anionic or zwitterionic polymers, or biocides that are combined with the hydrophobic or hydrophilic polymers that either make up the membrane structure or are surface treated on the membrane surface.

The (y) response for the linear portions of the curves generated in FIG. 5 are defined as being the service life of the membrane structure or the time required to reach the end of the induction period where strong fouling can take place. At t=0 there is no fouling for all the pure hydrophobic and pure hydrophilic membrane structures or surface treatments, as is the same for the same basic membrane compositions or treatments; but, are now combined with the ionic/nonionic/biocide additives which extend the lifetime of the membrane system.

At t=between 5 and 10 days—equations 1 and 2 (pure hydrophobic/hydrophilic systems)—the start of the biofilm growth takes place and the linear portion of the curve—now defined as the biofilm growth induction period—progresses for a given membrane system up to 20 days. After 20 days the start of the hard fouling processes can occur.

At t=between 5 and 20 days—equations 3 and 4 (combinations of the hydrophobic or hydrophilic membrane systems but now combined with critical concentrations of ionic/nonionic/biocide additive material)—the start of the biofilm growth (induction period) gets extended out to 30 days after which the possibility of hard fouling is more likely to occur.

Note! For all membrane systems, we define that any membrane surface or structure that either starts out with a water drop contact angle of around 30° to 70° (for this model we chose 50°) or starts with a high contact angle (100° or higher/hydrophobic surface) or a hydrophilic/ionic/biocide (5° to 20°) and progresses downward or upward to the critical point of 50° will see biofilm growth during this progression of time. In the pure hydrophobic membrane system the contact angle maintained its 100° contact angle until 10 days into the test at which point the biofilms started to grow decreasing its value to 50° approximately linearly up to a 20 day time period (equation 1). The combination of the ionic or nonionic materials in the hydrophobic membrane structure started out at a somewhat lower hydrophobic surface due to the choice of materials (80° and maintained this value up to 20 days exposure after which the biofilm started to grow and reached the critical point (contact angle of 50°) after which hard fouling can occur at 30 days (equation 3). Both hydrophilic systems started to progress towards biofilm formation after 5 days (the pure hydrophilic membrane had starting contact angle values of while the ionic/nonionic blend had contact angle values of about 20°), but the pure hydrophilic system lasted 20 days before reaching the critical value of 50° while the blend of the ionic or nonionic materials with the hydrophilic membrane structure to 30 days to reach this value (equations 2 and 4 respectively).

These experimentally derived results and equations are designated as relatively early examples of how membranes can be made with a general set of materials that can be manipulated to change the ability of a biofilm to grow and attach to the surfaces of different membrane systems. We now can use the linear equations that define the biofilm growth induction period from the experimental data of FIG. 5 and project how new improved membrane formulations should perform after 10× and 100× exposure times (Equations 5 through 12).

TABLE 20
Service Life Equations for 1x, 10x and 100x Projections

| (System) | | Service Life Equations (y) |
|---|---|---|
| (A) | Pure Hydrophobic | Equation 1 y = −4.889x + 147.78 |
| | Membrane | (x = 10 to 20 Days; FIG. 5) |
| (B) | Pure Hydrophilic | Equation 2 y = 2.6667x − 3.3333 |
| | Membrane | (x = 5 to 20 Days; FIG. 5) |
| (C) | Combination of | Equation 3 y = −3x + 140 |
| | Hydrophobic/Ionic/ | (x = 20 to 30 Days; FIG. 5) |
| | Nonionic/Biocide | |
| | Polymer Blends or | |
| | Surface Treatments | |
| (D) | Combinations of | Equation 4 y = 1.2x + 14 |
| | Hydrophilic/Ionic/ | (x = 5 to 30 Days; FIG. 5) |
| | Nonionic/Biocide | |
| | Polymer Blends or | |
| | Surface Treatments | |

| | |
|---|---|
| (A) | Equation 5 y = −0.4889x + 147.78 |
| | (10x projection where x = 100 to 200 Days) |
| (B) | Equation 6 y = 0.2667x − 3.3333 |
| | (10x projection where x = 50 to 200 Days) |
| (C) | Equation 7 y = −0.3x + 140 |
| | (10x projection where x = 200 to 300 Days) |
| (D) | Equation 8 y = 0.12x + 14 |
| | (10x projection where x = 50 to 300 Days) |
| (A) | Equation 9 y = −0.0489x + 147.78 |
| | (100x projection where x = 1000 to 2000 Days) |
| (B) | Equation 10 y = 0.0267x − 3.333 |
| | (100x projection where x = 500 to 200 Days) |
| (C) | Equation 11 y = −0.03x + 140 |
| | (100x projection where x = 2000 to 3000 Days) |
| (D) | Equation 12 y = 0.012x + 14 |
| | (100x projection where x = 500 to 3000 Days) |

### Example 14

### Nano and Micro Materials in Membranes

The use of nanosize TiO₂ particles or micron size iron oxide/hydroxide (made as follows: FeSO₄+2 OH⁻→Fe(OH)₂+SO₄²⁻) in the disclosed CTA/Nylon formulations can be used to control the flux and salt rejection of the membrane's transport properties, as reported in Table 20.

TABLE 21
Effect of nano/micron size particles
on membrane transport properties

| | Relative | % Salt |
|---|---|---|
| Membrane System | Flux | Rejection |
| CTA/Nylon | 2.6 | 75 |
| CTA/Nylon + 1% micron size Iron Hydroxide | 1.3 | 93 |
| CTA/Nylon + 1% nanosize Titanium Dioxide | 1 | 95 |

### Example 15

### Membrane Modifications for Arsenic Removal

It as been have discovered that if 10% by weight of an amino acid, such as, for example, cysteine (Aldrich), is added in the water quench bath used to prepare the CTA/Nylon membranes of this disclosure, then the amino acid becomes incorporated into the membrane structure and can be used to selectively remove arsenic (100 ppb sodium arsenide) from contaminated water. A membrane made using this additive in the quench bath process selectively decreased the 100 ppb sodium arsenide to 50 ppb over a 48-hour time period when exposed to the contaminated water.

As an alternative as shown in FIG. 5, particles of the disclosed, unique membrane-treating compositions can be placed within a caged screen or similar porous cage ahead of the membrane to pre-treat the sea water or other fluid followed by the membrane optionally treated with the same or a different disclosed, unique membrane-treating composition. Such a scheme has several advantages, such as, for example:
(a) fouling would only take place against the pre-treating filter, not the membrane;
(b) the pre-treating filter would filter particles and other solids ahead of the membrane;
(c) at least a portion of the desalinization could occur in the pre-treating filter;
(d) the pre-treating filter could be removed for regeneration; and
(e) the membrane could be removed for a much less aggressive regeneration.

The skilled artisan likely can evolve other advantages in using the pre-treating filter.

The size of the particles, density of the packed pre-treating filter; and other factors would determine the pressure drop and flow rate of the pre-treating filter. Much of the load would be taken from the expensive membrane and transferred to a less expensive (and easier to regenerate) pre-treating filter.

Referring to FIG. 5, salt water (or other fluid to be treated), 10, flows into a filter, 12, containing a packed bed of particles or one or more of the disclosed unique membrane treating compositions, 14. Pre-filtered or pre-treated water, 16, from filter 12 flows into an RO membrane, 18, from which a desalinized water, 20, exits. More than one filter can be used in series as needed or desired, with each performing the same or a different filtering/treating process. Also, biocides and other additives can be added to filter 12 and/or used to modify the particles.

While the device, compositions, and process have been described with reference to various embodiments, those skilled in the art will understand that various changes may be made and equivalents may be substituted for elements thereof without departing from the scope and essence of the disclosure. In addition, many modifications may be made to adapt a particular situation or material to the teachings of the disclosure without departing from the essential scope thereof. Therefore, it is intended that the disclosure not be limited to the particular embodiments disclosed, but that the disclosure will include all embodiments falling within the scope of the appended claims. In this application all units are in the metric system and all amounts and percentages are by weight, unless otherwise expressly indicated. Also, all citations referred herein are expressly incorporated herein by reference.

We claim:

1. A composition for forming or treating reverse osmosis (RO), forward osmosis (FO), microfiltration (MF), or nanofiltration (NF) membranes, which comprises:
a stable liquid blend of two of the following polymers: an oxygen polymer, a nitrogen polymer, and a sulfur polymer, where each polymer in a blend have matched solubility parameters; provided, that a nitrogen polymer can be in the form of a powder; where the weight ratio of polymers in each blend can range from 1:99 to 99:1; where each polymer optionally can be halogenated; where any polymer can be dispersed in a solvent for forming the blend.

2. The composition of claim 1, wherein said oxygen polymer is one or more of a cellulose acetate, a cellulose triacetate, an acrylic, acrylic modified alkyd, an epoxy, polyvinyl alcohol, polyvinyl chloride, polyvinyl acetate, or a polyester; said nitrogen polymer is one or more of a special nylon, an amine, a melamine, or a polyurethane; and said sulfur polymer is one or more of a polysulfide, a polysulfone, or a polyethersulfone.

3. The composition of claim 1, which additionally comprises one or more of amino acids, chelating agents, or nano or micro size particles or fibers.

4. The composition of claim 1, which is in the form of particles.

5. The composition of claim 1, which additionally comprises one or more of anionic polymers or oligomers; nonionic polymers or oligomers; cationic polymers oligomers; zwitterionic polymers; polymers that contain amino acids and chelating functionality; amino acids; chelating agents; micron or nanosize organic or inorganic materials; polymeric powders, zeolites; carbon fibers; polymeric fibers; inorganic fibers; graphene; epoxy/amine cross-linking agents; diisocyates; polyols; amines; or melamines; melamine/acids.

6. The composition of claim 1, which comprise one or more of 75%-90% cellulose acetate and 2%-25%% polyamide copolymer soluble in at least one solvent in which cellulose acetate is soluble; and 95% polyvinyl acetate and 5% polyamide copolymer soluble in at least one solvent in which polyvinyl acetate is soluble.
10% Nylon/90% CA
25% Nylon/75% CA
50% Nylon/50% CA
2% Nylon/98% CTA
4% Nylon/96% CTA
15% Nylon/85% CTA
5% Nylon/95% PVOAC
10% Nylon/90% CA/Mesh

7. A process for forming reverse osmosis (RO), forward osmosis (FO), or nanofiltration (NF) membranes, which comprises the steps of:
(a) casting a wet film or extruding a hollow fiber of a membrane composition comprising a stable liquid blend of two of the following polymers: oxygen polymer, a nitrogen polymer, and a sulfur polymer, where each polymer in a blend have matched solubility parameters; provided, that a nitrogen polymer can be in the form of a powder; where the weight ratio of polymers in each blend can range from 1:99 to 99:1; where each polymer optionally can be halogenated; where any polymer can be dispersed in a solvent for forming a blend;
(b) evaporating solvent from said cast film or extruded hollow fiber, where low solvent evaporation times produce an ultrafiltration or nanofiltration morphologies, medium solvent evaporation times produce FO morphology, and long evaporation times produce reverse osmosis morphology;
(c) water quench said evaporated cast film or extruded hollow fiber to solidify its structure, where the quench water optionally can contain one or more of inorganic or organic microparticles or nanoparticles; nonionic, anionic, cationic, zwitterionic polymers; or amino acids; and
(d) annealing at a temperature ranging between 50° C.-80° C. for 5 to 10 minutes said water quenched cast film or extruded hollow fiber, optionally wet with water and cosolvents.

8. The process of claim 7, wherein in step (b) low solvent evaporation times range up to 3 minutes; medium solvent evaporation time range between about 3 and 5 minutes; and long evaporation times range from between about 5 and 30 minutes.

9. The process of claim 7, wherein said oxygen polymer is one or more of a cellulose acetate, a cellulose triacetate, an acrylic, acrylic modified alkyd, an epoxy, polyvinyl alcohol, polyvinyl chloride, polyvinyl acetate, or a polyester; said nitrogen polymer is one or more of a special nylon, an amine, a melamine, or a polyurethane; and said sulfur polymer is one or more of a polysulfide, a polysulfone, or a polyethersulfone.

10. The process of claim 7, wherein said membranes in step (d) are microembossed.

11. The process of claim 7, wherein said cosolvents in step (d) comprise one or more of alkanols, inorganic microparticles or nanoparticles; organic microparticles or nanoparticles; nonionic polymers; anionic polymers; cationic polymers; zwitterionic polymers; or amino acids.

12. The process of claim 7, wherein said flat sheet membranes have an active about 0.1 to about 0.2 micron size dense layer on a about 1 to about 30 mils substrate layer; and said hollow has an outside diameter ranging between about 85 and about 2000 microns and an inside diameter ranging between about 42 and about 200 microns.

13. A method for making roll-to-roll nanoimprint embossing plates for nanoimprinting reverse osmosis (RO), forward osmosis (FO), or nanofiltration (NF) membranes, which comprises the steps of:
(a) photolithograph silicon wafers with a nano/micro pattern;
(b) cast a silicone polymer over said patterned silicon wafer;
(c) casting a thermoformed polyurethane over said patterned silicone polymer and curing said polyurethane; and
(d) electroplating said cured patterned polyurethane with metal to form a metal embossing plate for nanoimprinting reverse osmosis (RO), forward osmosis (FO), or nanofiltration (NF) membranes.

14. The composition of claim 13 nanoimprinted with the process of claim 13.

15. A method of treating reverse osmosis (RO), forward osmosis (FO), microfiltration (MF), or nanofiltration (NF) membranes, which comprises the steps of:
(a) coating one side of said membrane with the composition of claim 1; and
(b) applying suction to the other side of said membrane to pull said composition into the membrane pores without clogging them.

16. The method of claim 15, wherein said composition comprises a stable liquid blend of two of the following polymers: an oxygen polymer, a nitrogen polymer, and a sulfur polymer, where each polymer in a blend have matched solubility parameters; provided, that a nitrogen polymer can be in the form of a powder; where the weight ratio of polymers in each blend can range from 1:99 to 99:1; where each polymer optionally can be halogenated; where any polymer can be dispersed in a solvent for forming the blend.

17. The method of claim 15, wherein said oxygen polymer is one or more of a cellulose acetate, a cellulose triacetate, an acrylic, acrylic modified alkyd, an epoxy, polyvinyl alcohol, polyvinyl chloride, polyvinyl acetate, or a polyester; said nitrogen polymer is one or more of a special nylon, an amine, a melamine, or a polyurethane; and said sulfur polymer is one or more of a polysulfide, a polysulfone, or a polyethersulfone.

18. The method of claim 15, which additionally comprises one or more of amino acids, chelating agents, or nano or micro size particles or fibers.

19. The method of claim 15, which is in the form of particles.

20. A method for determining the biofilm induction period for a RO membrane and for determining how RO membrane compositions will perform after 10× and 100× exposure times, which comprises using the following equations:
Equation 5 y = −0.4889x + 147.78
(10x projection where x = 100 to 200 Days)
Equation 6 y = 0.2667x − 3.3333
(10x projection where x = 50 to 200 Days)
Equation 7 y = −0.3x + 140
(10x projection where x = 200 to 300 Days)
Equation 8 y = 0.12x + 14
(10x projection where x = 50 to 300 Days)
Equation 9 y = −0.0489x + 147.78
(100x projection where x = 1000 to 2000 Days)
Equation 10 y = 0.0267x − 3.333
(100x projection where x = 500 to 200 Days)
Equation 11 y = −0.03x + 140
(100x projection where x = 2000 to 3000 Days)
Equation 12 y = 0.012x + 14
(100x projection where x = 500 to 3000 Days)

21. A two-stage reverse osmosis (RO), forward osmosis (FO), microfiltration (MF), or nanofiltration (NF) unit, which comprises:
(a) a pre-filter comprising particles formed from a stable liquid blend of two of the following polymers: an oxygen polymer, a nitrogen polymer, and a sulfur polymer, where each polymer in a blend have matched solubility parameters; provided, that a nitrogen polymer can be in the form of a powder; where the weight ratio of polymers in each blend can range from 1:99 to 99:1; where each polymer optionally can be halogenated; where any polymer can be dispersed in a solvent for forming the blend; followed by
(b) a reverse osmosis (RO), forward osmosis (FO), microfiltration (MF), or nanofiltration (NF) membrane;

22. The two-stage unit of claim 21, wherein said membrane has been treated with a stable liquid blend of two of the following polymers: an oxygen polymer, a nitrogen polymer, and a sulfur polymer, where each polymer in a blend have matched solubility parameters; provided, that a nitrogen polymer can be in the form of a powder; where the weight ratio of polymers in each blend can range from 1:99 to 99:1; where each polymer optionally can be halogenated; where any polymer can be dispersed in a solvent for forming the blend
